(19) United States
(12) Patent Application Publication
(10) Pub. No.: US 2016/0282265 A1
(43) Pub. Date: Sep. 29, 2016

(54) Integrated Photonics Based Sensor System

(71) Applicant: Intel Corporation, Santa Clara, CA (US)

(72) Inventors: Xing Su, Cupertino, CA (US); Kadhair Al-Hemyari, Santa Clara, CA (US); Kai Wu, Mountain View, CA (US); Grace M. Credo, San Mateo, CA (US); Haisheng Rong, Pleasanton, CA (US); Jacob Sendowski, Palo Alto, CA (US)

(21) Appl. No.: 14/669,514

(22) Filed: Mar. 26, 2015

(51) Int. Cl. G01N 21/41

(52) U.S. Cl. CPC G01N 21/41

(57) ABSTRACT

An embodiment includes a sensor comprising a substrate die; a photonic ring resonator (RR) on the substrate die; a polymer, on the RR, having an affinity to a chemical analyte; a photonic waveguide on the substrate die and coupled to the RR; a laser, on the substrate die and coupled to the waveguide, to emit optical energy that operates with the RR at a resonance wavelength; and a photodetector, on the substrate die and coupled to the waveguide, to detect a change in refractive index (RI) of the RR operating with the optical energy in response to the polymer coupling to the analyte. Other embodiments are described herein.

### TECHNICAL FIELD

Embodiments of the invention are in the field of sensors.

### BACKGROUND

The ability to detect chemicals inside and around people helps inform choices such as where a person should sit, what that person should eat, as well as longer term decisions such as where that person should live. As the world becomes more industrialized, many man-made chemical compounds and/or natural compounds are collecting in new places at ever higher concentrations. These high concentrations, or even low concentrations, may be harmful to people. To reduce the risk of this harm, chemical sensors are used to effectively monitor and/or detect the presence of chemicals both in the environment and in people/animals themselves (e.g., biomarkers in skin, expired air, saliva, blood).

### BRIEF DESCRIPTION OF THE DRAWINGS

Features and advantages of embodiments of the present invention will become apparent from the appended claims, the following detailed description of one or more example embodiments, and the corresponding figures. Where considered appropriate, reference labels have been repeated among the figures to indicate corresponding or analogous elements.

FIG. 1 includes a schematic representation of a sensor system in an embodiment of the invention.

FIG. 2 includes a schematic diagram for optical phase locked loop feedback in an embodiment of a laser.

FIG. 3 includes a schematic of a customizable chemical interface for sensing analytes with selectivity and sensitivity in an embodiment.

FIGS. 4(a) and (b) include examples of analyte specific polymers in an embodiment of the invention.

FIGS. 5(a) and (b) depict signal enhancement by a refractive index enhancer in an embodiment of the invention.

FIG. 6 depicts a site-selective chemical synthesis process in an embodiment.

FIG. 7 depicts a system for use with various embodiments of the invention.

### DETAILED DESCRIPTION

Reference will now be made to the drawings wherein like structures may be provided with like suffix reference designations. In order to show the structures of various embodiments more clearly, the drawings included herein are diagrammatic representations of structures (e.g., circuits). Thus, the actual appearance of the fabricated structures (e.g., circuits), for example in a photomicrograph, may appear different while still incorporating the claimed structures of the illustrated embodiments. Moreover, the drawings may only show the structures useful to understand the illustrated embodiments. Additional structures known in the art may not have been included to maintain the clarity of the drawings. For example, not every layer of a semiconductor device is necessarily shown. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact.

As used herein, “analyte”, “biomarker”, and “target molecule” refer to molecules to be analyzed, detected, or sensed. Molecules are at times referred to as “biomarkers” when they originate from a biological system. A “volatile organic compound” (VOC) is a subclass of organic compounds and can present in gas or liquid form. A “sampling module” is part of a sensor system used to collect and transfer a sample to the sensing element or module. Some embodiments use different sampling modules for gas and liquid samples. A “sensing module” is part of a sensor system responsible for converting chemical information to measurable signals (e.g., electrical or optical). A “chemical interface” is a chemical polymer material that changes its properties to generate measurable signals when it interacts with analyte molecules. It is analyte-specific in some embodiments. A “transducer” is a physical device that can read signals generated from the chemical interface. A transducer is not analyte-specific. “Specificity” and “selectivity” are used interchangeably herein. Refractive index (RI) or index of refraction (n) of an optical medium is a dimensionless number that describes how light, or any other radiation, propagates through that medium. An “evanescent wave” is a near-field wave with an intensity that exhibits exponential decay without absorption as a function of the distance from the boundary at which the wave was formed.

An embodiment includes a compact, mobile (e.g., wearable), affordable, real-time, reusable sensing platform with high performance and reusability for real-time sensing of low concentrations of chemical analytes (e.g., biological environmental compounds). The embodiment includes a silicon photonic ring-resonator (RR) that is part of a transducer customized to identify analytes. The silicon based RR is compact (e.g., formed on a single substrate). The embodiment senses gas or liquid analytes.

An embodiment senses analytes with high sensitivity and selectivity, even when the analytes are present in low concentrations (e.g., on a parts per billion (ppb) level for gas analytes and a nanomole (nM) level for liquid analytes). The real-time capacity of the embodiment stands in contrast with conventional chemical sensors that are either expensive and immobile or exhibit low sensitivity and/or specificity.

An embodiment includes a sampling module, sensing module, and a data processing module. An embodiment described herein comprises the sensing module in particular and comprises a chemical interface and a transducer. The chemical interface interacts with analyte molecules selectively (target analyte recognition) and quantitatively. It further converts the analyte interaction (recognition) into a signal measurable by the transducer. An embodiment uses an integrated silicon photonics ring resonator as the transducer and customizable polymers for the chemical interface to form the sensing module.

Such embodiments may be stand-alone products included in wearables (e.g., watches, glasses, clothing that provide data about the wearer's body (e.g., calories burned, glucose levels) and/or environment (e.g., presence of VOCs, purity of drinking water)). However, embodiments may also cooperate with computer nodes located on different substrates from the sensors such as Smartphones (located on a different die or dies than the sensor). The sensors may communicate wirelessly with such a node to periodically upload data to a memory including a database or coupled to a database. The database may help a medical provider or epidemiologist track glucose levels over a period of time or exposure to specific allergens or dangerous ozone levels within the user's microclimate over a multi-day period.

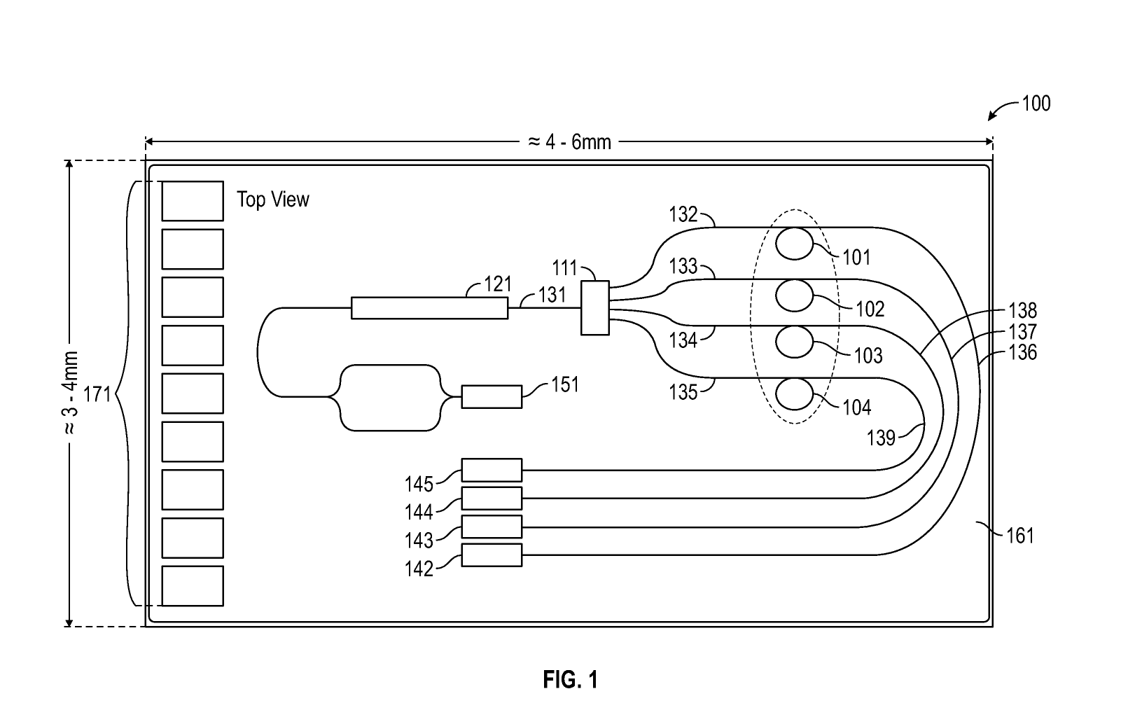

FIG. 1 includes a schematic representation of a sensor system in an embodiment of the invention. Sensor system 100 is formed on a single substrate die 161. System 100 includes semiconductor laser 121, which emits optical energy that is communicated to a beam splitter (BS) 111 by way of waveguide portion 131. BS 111 then directs optical energy to one or more ring resonators (RR) 101, 102, 103, 104 by way of waveguide portions 132, 133, 134, 135. Ring resonators 101, 102, 103, 104 then communicate the optical energy to photodetectors 142, 143, 144, 145 by way of waveguide portions 136, 137, 138, 139, which may couple to logic within the photodetectors or coupled thereto to detect RI shifts that correspond to the presence of target analytes in the sensor. System 100 may couple to other logic or system components (e.g., Smartphone) via contact pads 171.

FIG. 1 depicts an embodiment that uses surface chemistry modifications on photonic devices to sense analytes, wherein the photonic devices (e.g., RR 101, 102, 103, 104) are made on a substrate (e.g., Si). Laser 121 and photodectors 142, 143, 144, 145 (e.g., photodiodes) are integrated with the RRs on substrate 161 but may be from different substrates (but bonded to substrate die 161). Together, devices RR 101, 102, 103, 104, substrate 161, laser 121, and photodectors 142, 143, 144, 145 form an integrated photonic bio/chem sensor system that is located on a single die.

Laser 121 may include a single laser (e.g., a tunable InP laser) or a monolithic multi-wavelength laser array with lasers, each of which is constructed to emit light at a specified wavelength. The lasers in the group can simultaneously emit light beams of different wavelengths and can be selected individually when emission at a particular wavelength is called for. Laser 121 may be a hybrid laser where a III-V structure is wafer bonded onto a silicon-on-insulator wafer (e.g., substrate 161). Various types of lasers may be used in system 100. Such lasers include those described in, for example, U.S. Pat. No. 8,111,729 (assigned to Intel Corp., Santa Clara, Calif., USA), which describes a quantum well intermixing process that allows fabricating an array of lasers at multiple bandgaps without the need to bond multiple III-V wafers, and thus, allow lasers over a wide range of wavelengths in close physical proximity to one another. In addition, the patent describes a quantum well intermixing process that allows fabricating a broadband array of lasers that does not require multiple types of quantum wells for optical gain, and thus, has a high optical confinement factor which benefits laser performance. The patent describes a method including providing a silicon on an insulator wafer (e.g., substrate 161), patterning optical waveguides (e.g., waveguides 131, 132, 133, 134, 135, 136, 137, 138, 139), providing a III-V wafer comprising multiple layers, applying a quantum well intermixing process to the III-V wafer, performing wafer bonding, fabricating III-V mesa structures, and applying metal for p-type and n-type contacts.

Waveguides may be straight, curved, toroidal, annular or other designs. In some embodiments waveguides may be formed by grooves defined between elevated banks. In an embodiment laser 121 is on a III-V wafer that is bonded to a Si wafer upon which waveguides 131, 132, 133, 134, 135, 136, 137, 138, 139 are formed. Thus, the III-V wafer may be “on” the Si wafer and “on the same die” and vice versa where the Si wafer is “on” the III-V wafer.

In an embodiment laser 121 is a continuous frequency swept laser (FSL). This allows for continuous sensing via system 100. More specifically, continuous frequency swept laser 121 allows for a rapid and repeatable interrogation of the transmission spectrum of RRs 101, 102, 103, 104. In an embodiment the frequency of laser 121 is tuned with a ramped current injection signal. The signature of the ramped waveform is shaped to compensate for any nonlinear chirp in the laser diode. A chirp is a signal in which the frequency increases (‘up-chirp’) or decreases (‘down-chirp’) with time. Nonlinear chirp for the laser is measured using optical asymmetric Mach-Zehnder Interferometer (MZI) 151 and compensation for nonlinear chirp can be accomplished using optical phase locked loop (OPLL) feedback. A PLL is a control system that generates an output signal whose phase is related to the phase of an input signal.

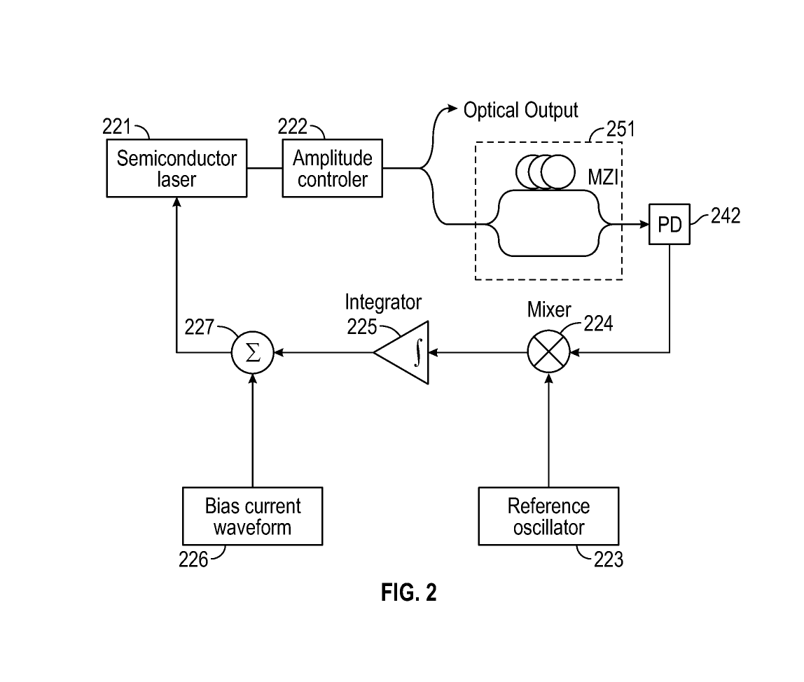

FIG. 2 includes a schematic diagram for OPLL in an embodiment. Optical components include laser 221, amplitude controller 222, and MZI 251. Electronics components include photo detector (PD) 242, mixer 224, oscillator 223, integrator 225, bias current waveform 226, and counter 227. An embodiment integrates the optical components of the OPLL circuit onto the Si transducer chip/die 161. The electronics signal processing can be done using a microprocessor chip.

In an embodiment, a portion of the nonlinear chirp compensation may be done using computationally based open loop bias current compensation (bias current waveform 226). The nonlinearity of the frequency chirp is measured and characterized in an open loop configuration. The necessary compensatory drive current is then calculated using a model for the laser current / frequency dynamics and is then programmed into the laser current driver.

The frequency swept laser leverages several unique properties of semiconductor lasers including size, narrow linewidth, output power, reliability, and low cost to produce optical frequency sweeps with bandwidths that are capable of covering the magnitude of frequency shifts encountered in measuring the effective RI change of the RR transducer. The FSL has no moving parts and generates precise, repeatable, highly linear frequency chirps.

RRs 101, 102, 103, 104 are structures that couple with light source 121 and photodetectors 142, 143, 144, 145. Optical RRs 101, 102, 103, 104 have a high quality factor (Q-factor) of more than 10⁵ in some embodiments. The Q-factor is a measure of the resonant photon lifetime within the microstructure, and therefore the Q-factor is directly correlated to the number of times a photon is recirculated and allowed to interact with targeted molecules on the surface. RRs rely on monitoring the changes in the resonant optical wavelength caused by the target molecules on the RR's surface. Therefore, molecule binding events perturb the effective index of the surface and elongate the effective optical path length within the ring and modify the resonance condition, resulting in a red shift in optical resonant frequency.

An embodiment may use various RRs, such as those described in U.S. Pat. No. 7,046,714 (assigned to Intel Corp., Santa Clara, Calif., USA), which illustrates an optical device including semiconductor material (e.g., substrate 161) having disposed thereon a silicon-based stimulated Raman scattering (SRS) laser/wavelength converter. The optical device is implemented using a silicon substrate for semiconductor material. The semiconductor material is part of a silicon-on-insulator (SOI) wafer. The optical device includes a pump laser, which generates a first optical beam of a first wavelength λ_{P} having a first power level. The optical beam is directed from a pump laser through a first optical waveguide defined in the semiconductor material. A first wavelength selective optical coupler is coupled to receive the optical beam at one of two inputs of an optical coupler. The optical coupler includes a first optical waveguide and a second optical waveguide disposed in semiconductor material. The second output of the optical coupler is optically coupled back to the second input of the optical coupler, which defines a first ring resonator in the semiconductor material.

In an embodiment, similar structures like laser 121 may also serve as a very efficient photodetector when it is reverse-biased. An embodiment integrates highly powered efficient lasers and photodetectors with passive optical devices and an array of RRs for sensing (via BS 111) on the same substrate. With system 100, in some embodiments the end user may only interface with electrical I/Os 171 and the photonics are fully embedded in the SOI chip 161. The integration of laser 121 and PDs 142, 143, 144, 145 with the sensing transducers/RRs 101, 102, 103, 104 eliminates/reduces the need for complex optical I/Os and the need for discrete, expensive, and bulky manipulation optics. This technology enables the fabrication of complex optoelectronic circuits with increased reliability, reduced cost, and small form factor.

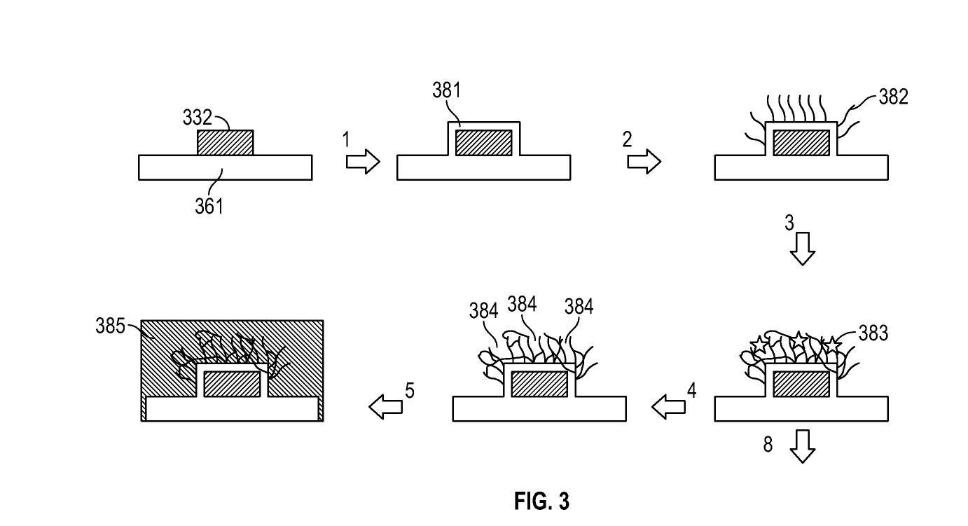

FIG. 3 includes a schematic of a customizable chemical interface polymer for sensing analytes with selectivity and sensitivity in an embodiment. In order to transform RRs 101, 102, 103, 104 into custom sensors, a chemical interface that is usage-specific is conjugated on the transducer/RR surface. An embodiment provides a chemical interface that has selective interactions with target analytes and those interactions induce significant effective RI change (thereby increasing sensitivity of the system). The embodiment provides that the analyte/chemical interface is positioned within the evanescent field of the RR guided optical mode. Further, in an embodiment the chemical interface itself is not chemically reactive like enzymes or antibodies that denature during or as a result of sensing such that its components are chemically stable (thereby making the system reusable).

In FIG. 3, a molecular imprinted polymer (MIP) is created using target molecules as the templates to create molecular cavities in the polymer that can only be used to bind the target molecules or molecules with similar molecular structures. Thus, a MIP can ensure specificity. More specifically, FIG. 3 depicts MIP fabrication over a RR surface. Waveguide 332 is formed over substrate 361 and then covered with silicon oxide 381. A monolayer of monomers 382 is coupled to oxide 381 (e.g., covalently) and then “templated” or “programmed” with analytes 383. A monolayer polymer initiator is used to control polymer thickness over silicone waveguide 332. After the analytes are removed, MIP 384 is produced. Portions of MIP 384 may be covered with a reversible protection layer 385 (e.g., photoresist, oxide), which may be removed in areas to provide windows such that analyte may be given a chance to interact with MIP 384 for sensing.

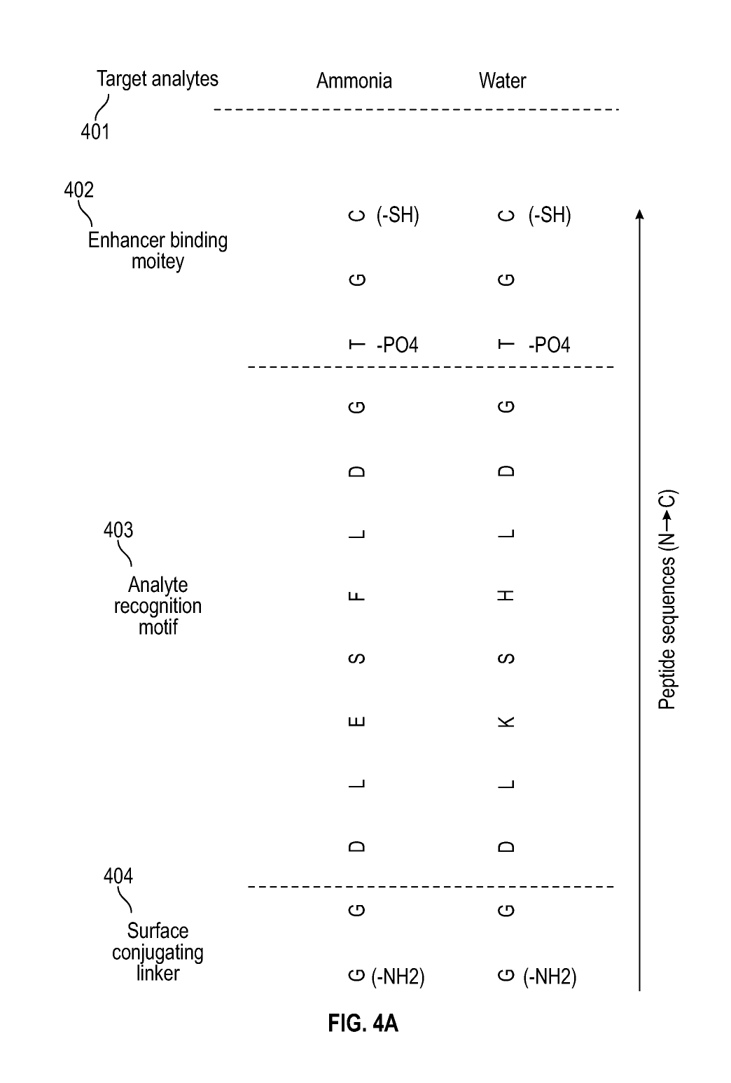

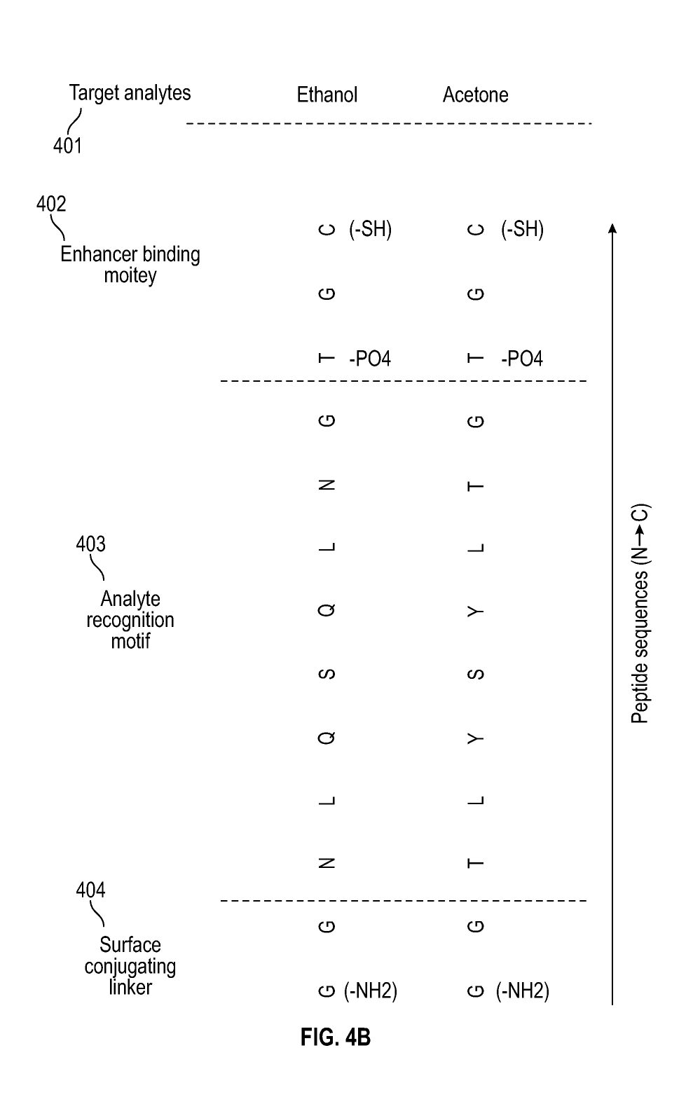

FIGS. 4(a) and (b) includes examples of analyte specific polymers in an embodiment of the invention. To structurally and functionally couple analyte-selective polymers with RR transducers, embodiments use various amino acid-based peptide polymers to coat RRs. Embodiments include polymers that include: (a) a recognition motif 403 that is designed to interact with target analytes 401; (b) an enhancer binding moiety 402, such as a thiol group that can bind to a much larger nanoparticle, and (c) a surface conjugation linker 404, containing functional groups, selected from the group comprising amines, carboxyls, aldehydes, thiols, hydroxyls, and epoxies. A moiety is part or functional group of a molecule.

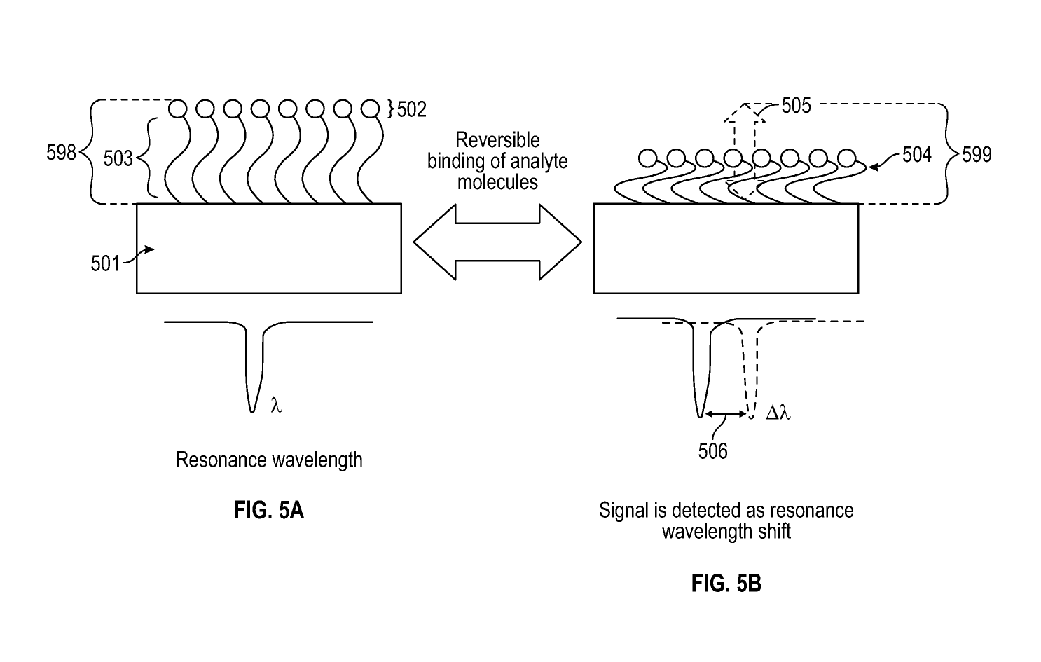

FIGS. 5(a) and (b) depict signal enhancement by RI enhancer 502 in an embodiment of the invention. In FIG. 5(a), recognition motif 503 interacts specifically with target analytes, causing a conformational change of the polymer (FIG. 5(b)) that changes the effective RI (506) on the surface of optical RR transducer 501. The recognition motif is designed to respond to one or more of the target analyte chemical properties, such as charge, polarity and hydrophobicity, causing an observable conformational change upon the interaction with the target analyte molecules. Recognition motif 503 and enhancer binding moiety 502 have a thickness 598 less than the thickness 599 of evanescent field 505.

Regarding charge, ammonia (for example) can become positively charged when it encounters water in a relatively low pH environment. Therefore, a negatively charged capture matrix material can be used to attract ammonia. As another example, when metal ions (positively charged) are the analytes (e.g., heavy metals in water for foods), the capture polymers may be negatively charged. While charge alone may not provide absolute specificity, the use of charge may help achieve specificity in cooperation with other concepts such as MIP.

Embodiments use peptides (e.g., element 382 of FIG. 3) because they are stable biomolecules that can be derived from various functional proteins (e.g., cell membrane receptors, enzymes and antibodies) with defined structures and binding specificities. The structure of the recognition polymer (peptide) is designed to enable additional or enhanced functionalities by coupling with specific chemical groups. Unlike large, structurally complex proteins, the stability of short peptides allows repeated use cycles.

For embodiments that sense analytes in liquid, aptamers may be used. Aptamers are highly selective polymers for recognizing a wide variety of analytes types such as bacteria, cells, viruses, proteins, nucleotide sequences, heavy metals, organic and inorganic compounds for environmental and health related sensing applications. Specifically, aptamers may be oligonucleotide or peptide molecules that bind to a specific target molecule. Since aptamers are artificial nucleic acid ligands they can be designed for target analytes and generated by in vitro selection through partition and amplification. Aptamers are structurally versatile because they have basic stem-loop arrangements that form proper three-dimensional structures. These structures facilitate the formation of a complex with the target molecule to influence the target's function. Aptamers have high affinities to their targets, with dissociation constants at the low-picomolar (pM) level, comparable to or better than antibodies, including better stability, no batch variation, smaller sizes, and easier modification. Aptamers can be implemented as reusable sensing elements with the RR based platform 100. Other embodiments use still other forms of chemical interface, such as fluorine-containing polymers (F-polymer).

Returning to FIGS. 4(a) and (b), enhancers are used in some embodiments to increase transducer sensitivity. Enhancers may use a variety of chemical polymers that have a relatively high RI. They include complexes containing halogen elements, sulfur or phosphorus-containing groups (e.g., see thiols in element 402), organometallic components or metal nanoparticles. These complexes can be made separately and then conjugated with the chemical interface polymer. They can also be part of the chemical interface polymer molecules that are synthesized in the same process. For example, gold nanoparticles (AuNPs) can be used as RI enhancers. AuNPs range in size from 1 nm to 100 nm and can be conjugated to peptide polymers containing thiol groups after the peptides are conjugated to the transducer surface. The peptide polymers can also be conjugated to a nanoparticle surface (e.g., AuNP) before being attached to a RR/transducer surface. Enhancers operate by increasing the overlap integral of the molecules/particles with the evanescent field of the RR guided mode. Therefore, when the distribution and/or distance of the larger molecules/AuNPs to the surface shifts upon interaction with the targeted molecule and subsequent conformation change of the polymers (e.g., element 504 of FIG. 5(b)), the effect on the guided mode evanescent field is amplified, enhancing the RR sensitivity.

An embodiment may include a surface plasmon resonator (SPR) in addition to or in place of RRs. SPR is a RI sensing method and more precisely, SPR is the resonant oscillation of conduction electrons at the interface between a negative and positive permittivity material stimulated by incident light. Alternative lasers may be used with embodiments including a SPR in order to accommodate the wide resonance linewidth of SPR resonators. Other embodiments may use other integrated resonators (instead of or in addition to RRs) such as microdisks, inline brag minor based resonators, and photonic crystal defect resonators, and the like.

An embodiment utilizes interface thickness and multiplexing (e.g., using a multiplexor and/or beam splitter) to address sensitivity, selectivity and usage. Specifically, an embodiment enables sensing from multiple sites on the same chip. This multiplexing capability (e.g., via BS 111) provides a way to perform nonspecific sensing at a site (e.g., RR 104) that can be used as a control for physical conditions so that data can be used to normalize sensing data (e.g., RR 101). For example, to ensure a RR does not incorrectly respond to environmental factors (e.g., temperature, pressure, and movement), such environmental noise or context is controlled for with a reference channel. Multiple sensors can also be used to ensure sensing specificity by signature recognition (e.g., RR 101 and 102 can both target the same analyte). Multiple sensing sites also enable detection of multiple chemical analytes which can broaden usage capability (e.g., RR 101 and 102 can target different analytes).

An embodiment uses “differential measurement” for sensing. For example, two RR sensors (e.g., RRs 101, 102) may be placed adjacent each other. One of the sensors may have an analyte specific capture polymer (e.g., RR 101) and the other may not (e.g., RR 102). When both are exposed to a sample they will respond to physical and chemical changes. However, there will be a difference between the two RR's reactions (e.g., RI shift) and the difference is caused by the analyte being sensed by the RR sensor with the analyte specific capture polymer (e.g., RR 101).

Regarding chemical interface polymer thickness control, controlling thickness is advantageous for at least two reasons: to achieve high sensitivity and to ensure reproducibility across a transducer array (e.g., RR's 101, 102, 103, 104). RI-based sensing depends on the RI change within the evanescent field of the transducer. In an embodiment, a RR transducer has an effective evanescent field within about 100 nm of the waveguide surface. In such an embodiment, if the polymer layer is greater than 100 nm the target analyte molecules interact with the outmost polymer molecules first, or are quenched by the outer region of the polymer layer, without being detected. In order to ensure sensor reproducibility across sensing sites within a chip or sensors among different wafer lots, the embodiment maintains a consistent thickness of the chemical interface layer.

Embodiments include different approaches to coating the polymer to the RR or other transducer. For example, embodiments include at least two different approaches for surface coating or modification of the transducer with organic polymers. One embodiment allows polymer to polymerize once an initial layer of the polymer molecules are bonded or adsorbed on the RR surface. In this case, the thickness of the polymer layer is governed by many factors, including solvents used, concentration of polymers, density of functional groups, and time allowed for crosslinking. Another embodiment performs surface initiated, layer-by-layer conjugation. Because the polymer molecular structure used for each layer is well defined, its thickness can be calculated and verified by analytical analysis. As shown in FIG. 4, in an embodiment each peptide molecule has a linker region 404 that can be cross-linked with a carboxyl or aldehyde group on the surface. The peptide molecules do not cross-link and thus the thickness of the peptide layer is fixed. In an embodiment where the peptides are in a helix conformation, a 13-amino acid peptide structure (e.g., elements 404, 403, and 402) will have a length of about 2 nm (0.15 nm/amino acid).

To adjust the polymer layer thickness without changing the molecular structures, embodiments follow various approaches. An embodiment varies the thickness by using branched polymers of desired molecule weight (e.g., 1 K Da to 100 K Da) of certain neutral polymers (e.g., PEG or dextrose) before the peptide molecules are conjugated. Another embodiment conjugates peptides layer-by-layer to form multi-layers of desired peptides or peptides with other polymers. Another embodiment uses nanoparticles (e.g., AuNPs) of different size as carriers to bring desired polymers to transducer surfaces.

An embodiment uses multiple transducers/sensors (all on a single die) to ensure specificity and multiplexing detection of chemical analytes. The transducers are modified with different polymers that are either pre-synthesized beforehand or in-situ synthesized. For example, a manufacture may ship sensors before the molecular imprinting takes place (leaving the imprinting step to the customer). An embodiment achieves site-selective modification on a RR via inkjet-printing. Another embodiment achieves site-selective modification on a RR via screen printing. Printing may have a relatively larger spot (feature) size, typically over 100 um. The shape of the spot may be round or irregular. Other embodiments use a photoresist patterning process, in which given sites are accessible to the reagent (coating chemicals) while other sites not to be modified are protected by a photoresist. The protection and stripping steps can be repeated for multiple site surface modifications. This can be done in single die or wafer level. Furthermore, multiple steps on the same site can be performed to synthesize desired chemical polymers in situ. Use of a photolithography process generates small features such that different features (e.g., different chemical contents) can be made within a small space (<100 um). Also, the shape of the spot may have straight boundary lines as opposed to printing.

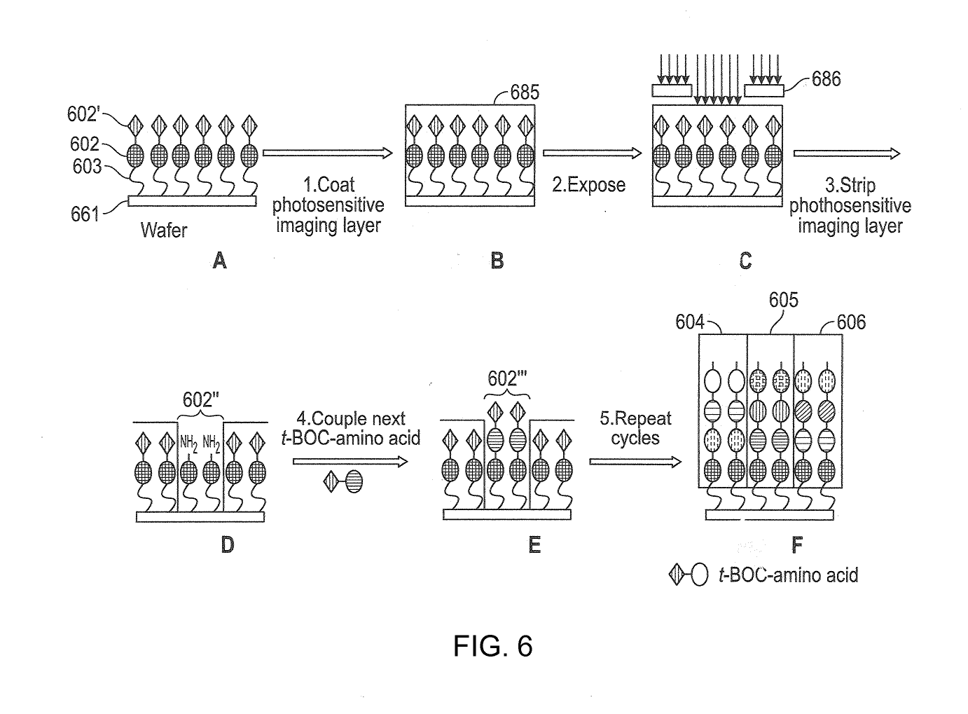

For example, FIG. 6 depicts a site-selective chemical synthesis process in an embodiment. In stage A wafer 661 is presented with analyte recognition motif 603 and enhancers 602, 602′. In stage B photoresist (PR) 685 is deposited and then exposed with mask 686 in place at the location in stage C, which strips the PR away so additional enhancer 602″ (e.g., amine) can be conjugated to moiety 603 (stage D). Afterwards, the peptide may be further constructed with additional components 602′″ (e.g., t-BOC amino acid) stage E. In stage F PR may be added/removed at various other locations of the same RR or different RRs to allow for other sensing sites of the same analyte or different analytes.

Embodiments have many uses such as detecting dehydration (i.e., checking salt concentrations in urine or plasm), cardiopulmonary stress testing, indirect calorimetry, maximal oxygen consumption, sweat analysis, breath analysis (for exercise purposes or to gauge inebriation), and the like. An embodiment may be coupled with physical sensors (e.g., accelerometer) on the same substrate or a different substrate as sensor system 100. Measuring both physical and chemical information may provide for better assessment of the body's state.

An embodiment provides high sensitivity, which is required for chemical analytes originated from the body (VOCs from skin or breath). High sensitivity allows short sampling times with limited analyte volumes, which is helpful with skin gas and sweat-based monitoring.

Embodiments include reversible chemistry, such as recognition elements (chemical interface) based on human olfactory receptors that enable reusable sensors with no need for immediate replacement/disposal of the sensor cartridge.

An embodiment includes logic to analyze data and provide actionable feedbacks to users. That logic may be included on substrate 161 or coupled thereto (e.g., on a Smartphone or die adjacent die 161). The logic may take into account other factors besides those directly sensed. For example, in fitness usage the level of acetone or ammonia may not necessarily represent the body chemical or physiological conditions because they can be produced in high level due to protein rich (ammonia indicator) or fat-rich (acetone indicator) diets. When analyzing the data, other factors (e.g., diet) may be taken into consideration.

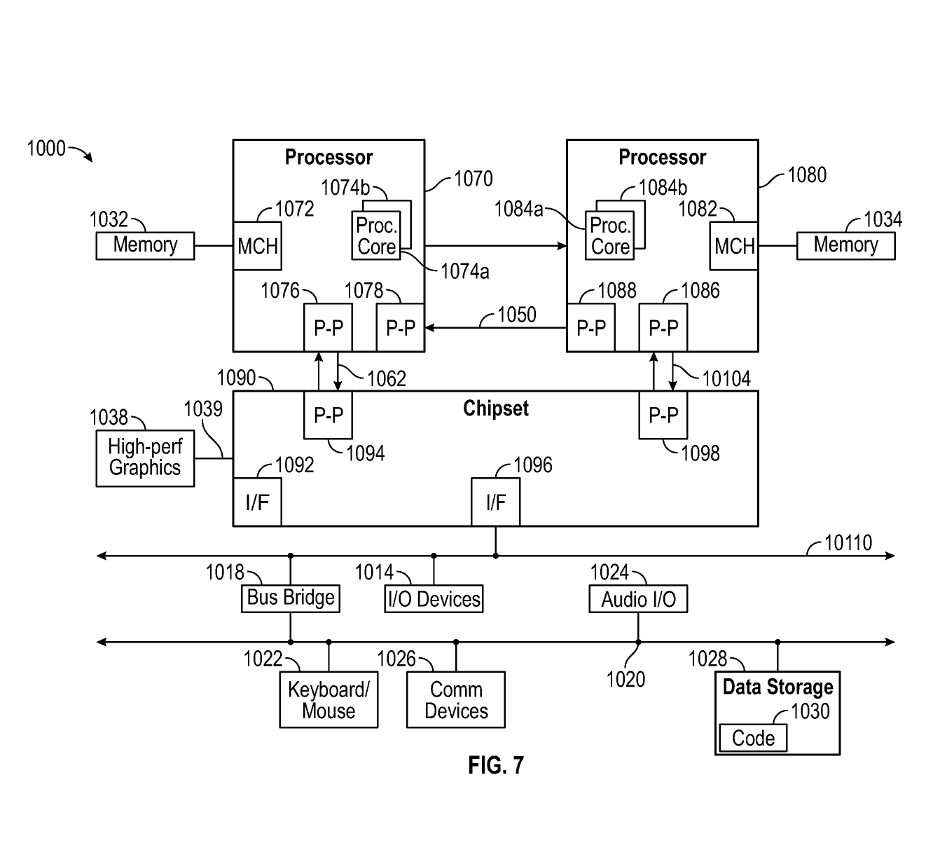

The system of FIG. 7 may be used to implement this logic. In fact, embodiments may be used in many different types of systems. For example, in one embodiment a communication device can be arranged to perform analysis described herein. Of course, the scope of the present invention is not limited to a communication device, and instead other embodiments can be directed to other types of apparatus for processing instructions.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein (e.g., determining if a detected analyte, in combination with a second detected analyte, satisfies a threshold condition which upon satisfaction should be communicated to a user) may be provided as (a) a computer program product that may include one or more machine readable media having stored thereon instructions that may be used to program a processing system or other electronic device to perform the methods or (b) at least one storage medium having instructions stored thereon for causing a system to perform the methods. The term “machine readable medium” or “storage medium” used herein shall include any medium that is capable of storing or encoding a sequence of instructions (transitory media, including signals, or non-transitory media) for execution by the machine and that cause the machine to perform any one of the methods described herein. The term “machine readable medium” or “storage medium” shall accordingly include, but not be limited to, memories such as solid-state memories, optical and magnetic disks, read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, as well as more exotic mediums such as machine-accessible biological state preserving or signal preserving storage. A medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

Referring now to FIG. 7, shown is a block diagram of a system embodiment 1000 in accordance with an embodiment of the present invention. System 1000 may be included in, for example, a mobile computing node such as a cellular phone, smartphone, tablet, Ultrabook®, notebook, laptop, personal digital assistant, and mobile processor based platform.

Shown is a multiprocessor system 1000 that includes a first processing element 1070 and a second processing element 1080. While two processing elements 1070 and 1080 are shown, it is to be understood that an embodiment of system 1000 may also include only one such processing element. System 1000 is illustrated as a point-to-point interconnect system, wherein the first processing element 1070 and second processing element 1080 are coupled via a point-to-point interconnect 1050. It should be understood that any or all of the interconnects illustrated may be implemented as a multi-drop bus rather than point-to-point interconnect. As shown, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to methods discussed herein.

Each processing element 1070, 1080 may include at least one shared cache. The shared cache may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. MC's 1072 and 1082 couple the processors to respective memories, namely a memory 1032 and a memory 1034, which may be portions of main memory locally attached to the respective processors. While MC logic 1072 and 1082 is illustrated as integrated into the processing elements 1070, 1080, for alternative embodiments the MC logic may be discreet logic outside the processing elements 1070, 1080 rather than integrated therein.

First processing element 1070 and second processing element 1080 may be coupled to an I/O subsystem 1090 via P-P interfaces 1076, 1086 via P-P interconnects 1062, 10104, respectively. As shown, I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, a bus may be used to couple graphics engine 1038 to I/O subsystem 1090. Alternately, a point-to-point interconnect 1039 may couple these components.

In turn, I/O subsystem 1090 may be coupled to a first bus 10110 via an interface 1096. In one embodiment, first bus 10110 may be a Peripheral Component Interconnect (PCI) bus, or a bus such as a PCI Express bus or another third generation I/O interconnect bus, although the scope of the present invention is not so limited.

As shown, various I/O devices 1014, 1024 may be coupled to first bus 10110, along with a bus bridge 1018 which may couple first bus 10110 to a second bus 1020. In one embodiment, second bus 1020 may be a low pin count (LPC) bus. Various devices may be coupled to second bus 1020 including, for example, a keyboard/mouse 1022, communication device(s) 1026 (which may in turn be in communication with a computer network), and a data storage unit 1028 such as a disk drive or other mass storage device which may include code 1030, in one embodiment. The code 1030 may include instructions for performing embodiments of one or more of the methods described above. Further, an audio I/O 1024 may be coupled to second bus 1020.

Note that other embodiments are contemplated. For example, instead of the point-to-point architecture shown, a system may implement a multi-drop bus or another such communication topology. Also, the elements of FIG. 7 may alternatively be partitioned using more or fewer integrated chips than shown in the FIG. 7.

Sensor system 100 may interact with sampling and processing modules (e.g., element 1070 or 1090 of FIG. 7) located on different dies/substrates.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

An embodiment is usable as a fitness monitor that tracks volatile gases detectable from a human body (e.g., ketones, aldehydes, alkanes, ammonia). Such skin volatile analytes are used as biomarkers for fitness tracking. For example, acetone is used as an indicator for fat burning (one of the calorie sources) and ammonia is an indicator of dehydration.

Various embodiments include a semiconductive substrate. Such a substrate may be a bulk semiconductive material this is part of a wafer. In an embodiment, the semiconductive substrate is a bulk semiconductive material as part of a chip that has been singulated from a wafer. In an embodiment, the semiconductive substrate is a semiconductive material that is formed above an insulator such as a semiconductor on insulator (SOI) substrate. In an embodiment, the semiconductive substrate is a prominent structure such as a fin that extends above a bulk semiconductive material.

The following examples pertain to further embodiments.

Example 1 includes a sensor comprising: a substrate die; a photonic ring resonator (RR) on the substrate die; a polymer, on the RR, having an affinity to a chemical analyte; a photonic waveguide on the substrate die and coupled to the RR; a laser, on the substrate die and coupled to the waveguide, to emit optical energy that operates with the RR at a resonance wavelength; and a photodetector, on the substrate die and coupled to the waveguide, to detect a change in RI of the RR operating with the optical energy in response to the polymer conjugating with the analyte.

As used herein a die in the context of electronics is a small block of semiconducting material, on which a given functional circuit is fabricated. Typically, integrated circuits are produced in large batches on a single wafer of silicon or other semiconductor through processes such as photolithography. The wafer is cut (“diced”) into many pieces, each containing one copy of the circuit. Each of these pieces is called a die.

As used herein, “conjugated” connotes a structure is formed by the union of two compounds or elements (e.g., an analyte to the polymer). Conjugating, as used herein, does not necessarily require covalent attachment.

Another version of example 1 includes a sensor comprising: a substrate die; a photonic ring resonator (RR) on the substrate die; a polymer, on the RR, having an affinity to a chemical analyte; a photonic waveguide on the substrate die and coupled to the RR; a laser, on the substrate die and coupled to the waveguide, to emit optical energy that operates with the RR at a resonance wavelength; and a photodetector, on the substrate die and coupled to the waveguide, to detect a change in refractive index (RI) of the RR that occurs in response to the polymer coupling to the analyte.

In example 2 the subject matter of the Example 1 can optionally include, wherein the polymer has the affinity to the analyte when the polymer includes a member selected from the group comprising: a molecular imprint specific to the analyte, a physical printing specific to the analyte, and a photolithographed printing specific to the analyte.

As used herein, “having an affinity to a chemical analyte” includes having a specificity to an analyte which is used to sense the analyte (e.g., a MIP has an affinity to the analyte the MIP was programmed (e.g., imprinted) with).

In example 3 the subject matter of the Examples 1-2 can optionally include, wherein the analyte is selected from the group comprising liquid ketones, liquid alcohols, liquid aldehydes, volatile organic compounds (VOCs), metal ions, biomarkers, and hormones.

In another version of example 3 the subject matter of the Examples 1-2 can optionally include, wherein the analyte is selected from the group comprising liquid ketones, liquid alcohols, liquid aldehydes.

VOCs may include, without limitation, Chloromethane, Bromomethane, Vinyl chloride, Chloroethane, Methylene chloride, Acetone, Carbon disulfide, 1,1-Dichloroethene, 1,1-Dichloroethane, Total-1,2-dichloroethene, Chloroform, 1,2-Dichloroethane, 2-Butanone, 1,1,1-Trichloroethane, Carbon tetrachloride, Vinyl acetate, Bromodichloromethane, 1,2-Dichloropropane, Cis-1,3-dichloropropene, Trichloroethene, Dibromochloromethane, 1,1,2-Trichloroethane, Benzene, Trans-1,3-dichloropropene, Bromoform, 4-Methyl-2-pentanone, 2-Hexanone, Tetrachloroethene, 1,1,2,2-Tetrachloroethane, Toluene, Chlorobenzene, Ethylbenzene, Styrene, and Total Xylenes.

Analytes may be in a gaseous phase, including the above VOCs and/or other VOCs from farms, industries, a person's breath or skin, and the like. The above mentioned metal ions may include, for example, K+, Na+, Mg++, Hg+, and the like. Analytes may further include small organic molecules (e.g., bisphenolic A, antibiotics, depressants, herbicides, and the like), biomarkers (e.g., troponin, c-reactive proteins, IL-6, IgE, and the like), and steroids and/or other hormones. Analytes in liquid phase may be included in water, a soil extract, a food extract, blood, urine, saliva, and other bodily fluids.

Analytes may also include liquid esters, carboxylic acids, ethers, amines, halohydrocarbons (e.g., including F, Cl, Br, and/or I). Biomarkers may include small molecules, proteins, carbohydrates, nucleic acids, and/or lipids. Hormones may include vitamins, proteins and/or polypeptides.

In example 4 the subject matter of the Examples 1-3 can optionally include wherein the polymer is reusable and does not degrade in response to sensing the analyte.

For example, an enzyme based sensor may not be reusable as the enzyme is consumed in performing the initial sensing.

In example 5 the subject matter of the Examples 1-4 can optionally include an array of RRs, on the substrate die, including the RR.

In example 6 the subject matter of the Examples 1-5 can optionally include wherein each of the RRs includes a chemical imprint specific to the analyte.

In another version of example 6 the subject matter of the Examples 1-5 can optionally include wherein each of the RRs includes a chemical affinity specific to the analyte.

In example 7 the subject matter of the Examples 1-6 can optionally include wherein an addition one of the RRs includes an additional chemical imprint specific to an additional chemical analyte that is different from the analyte.

In another version of example 7 the subject matter of the Examples 1-6 can optionally include wherein an addition one of the RRs includes an affinity specific to an additional chemical analyte that is different from the analyte.

In example 8 the subject matter of the Examples 1-7 can optionally include an additional waveguide and a multiplexor coupled to the waveguide and the additional waveguide.

In another version of example 8 the subject matter of the Examples 1-7 can optionally include an additional waveguide and a beam splitter coupled to the waveguide and the additional waveguide.

In example 9 the subject matter of the Examples 1-8 can optionally include, wherein the polymer includes a single functional group having only one site on the polymer that is reactive with another molecule under a given conjugation chemistry condition.

In another version example 9 the subject matter of the Examples 1-8 can optionally include, wherein the polymer molecules are grafted or conjugated to the surface so that the analyte recognition motif are less than 100 nm away from the RR surface.

In an embodiment, for molecular imprinted polymers the monomers are cross-linked to the form the polymers. For peptides, the polymer may have only one functional group. This help control the thickness of the polymer so that the binding/coupling occurs within the evanescent field (<100 nm).

“Single functional group”, as used herein, means only one site on the polymer is reactive with another molecule under a given conjugation chemistry condition. For example, in a sequential 2-step EDC chemistry, the carboxyl groups on the surface can first be activated with N-hydroxysulfosuccinimide (NHS). Peptide molecules can then be added to allow the primary amine group on each peptide molecule to react with a NHS ester on the surface. In this procedure, peptide molecules will not be cross-linked because the carboxyl groups on the peptide molecules are not activated by NHS.

In example 10 the subject matter of the Examples 1-9 can optionally include wherein the emitted optical energy has an evanescent field and the polymer is thinner than a thickness of the evanescent field.

In example 11 the subject matter of the Examples 1-10 can optionally include wherein the waveguide couples to the polymer via an oxide layer.

For example, in an embodiment the polymer does not couple to the oxide directly. The oxide is modified first with silane, phosphonate or other attachment chemistry. The modifying molecule may terminate with a functional group selected from the group comprising amines, carboxyls, aldehydes, thiols, hydroxyls, and epoxies.

In another version of example 11 the subject matter of the Examples 1-10 can optionally include wherein the optical waveguide or ring resonator couples to the polymer via an oxide layer.

In example 12 the subject matter of the Examples 1-11 can optionally include wherein the polymer couples to the oxide layer via a member selected from the group comprising amines, carboxyls, aldehydes, thiols, hydroxyls, and epoxies.

For example, in an embodiment the polymer does not couple directly to the oxide layer.

In example 13 the subject matter of the Examples 1-12 can optionally include wherein the polymer terminates with a member selected from a group comprising thiols and gold, the member being configured to enhance the change in RI when the polymer couples to the analyte.

In another version of example 13 the subject matter of the Examples 1-12 can optionally include wherein the polymer terminates with a high-refractive-index polymer element, comprising an RI greater than 1.7, configured to enhance the change in RI in response to the polymer conjugating with the analyte.

In yet another version of example 13 the subject matter of the Examples 1-12 can optionally include wherein the polymer terminates with a high-refractive-index polymer element, comprising an RI greater than 1.7, configured to enhance the change in RI in response to the polymer coupling to the analyte.

For example, high-refractive-index polymer elements may include linear thioether and sulfone, cyclic thiophene, thiadiazole, thianthrene, thianthrene, tetrathiaanthracene, phosphonates, phosphazenes, Polyphosphonates, Polyferrocenylsilanes, polyferrocenes containing phosphorus spacers and phenyl side chains, TiO₂, ZrO₂, amorphous silicon, PbS and ZnS.

In other embodiments, the high-refractive-index polymer element may comprise an RI greater than 1.3, 1.4, 1.5, 1.6, 1.8, 1.9, or 2.0.

In example 14 the subject matter of the Examples 1-13 can optionally include wherein the polymer includes a member selected from the group comprising peptides and aptamers.

In example 15 the subject matter of the Examples 1-14 can optionally include a control transducer on the substrate die that does not include a molecularly imprinted polymer (MIP) with an affinity to the analyte.

For example, the control transducer may be specific (i.e., “have an affinity for”) a different analyte (e.g., fructose) than the analyte primarily being sensed (e.g., glucose).

In example 16 the subject matter of the Examples 1-15 can optionally include wherein the polymer includes a molecularly imprinted polymer (MIP).

In example 17 the subject matter of the Examples 1-16 can optionally include a phase locked loop (PPL) on the substrate die and coupled to the laser; wherein the laser is tunable and the photodetector includes a photodiode.

Example 18 includes a sensor comprising: a substrate die; a transducer on the substrate die; a polymer, on the transducer, configured to include a programmed affinity to a chemical analyte; a photonic waveguide on the substrate die and coupled to the transducer; a laser, on the substrate die and coupled to the waveguide, to emit optical energy that operates with the transducer at a resonance wavelength; and a photodetector, on the substrate die and coupled to the waveguide, to detect a change in refractive index (RI) of the transducer operating with the optical energy in response to the polymer conjugating with the analyte.

As used herein, “programming” a polymer connotes instilling an affinity to a chemical analyte (e.g., imprinting a polymer to create a MIP).

For example, a manufacture may ship the embodiment of example 18 without the polymer having been programmed. The manufacturers customer may instead program the polymer at a later time.

Another version of example 18 includes a sensor comprising: a substrate die; a transducer on the substrate die; a polymer, on the transducer, configured to include a programmed affinity to a chemical analyte; a photonic waveguide on the substrate die and coupled to the transducer; a laser, on the substrate die and coupled to the waveguide, to emit optical energy that operates with the transducer at a resonance wavelength; and a photodetector, on the substrate die and coupled to the waveguide, to detect a change in refractive index (RI) of the transducer that occurs in response to the polymer coupling to the analyte.

In example 19 the subject matter of the Example 18 can optionally include wherein the polymer is reusable and does not degrade in response to sensing the analyte when the polymer is programmed to include the affinity to the analyte.

In example 20 the subject matter of the Examples 18-19 can optionally include wherein the transducer is selected from the group comprising a ring resonator (RR) and a surface plasmon resonator (SPR).

In example 21 the subject matter of the Examples 18-20 include an array of transducers.

In example 22 the subject matter of the Examples 18-21 can optionally include wherein the polymer includes a molecularly imprinted polymer (MIP) specific to the analyte.

In another version of claim 22 the subject matter of the Examples 18-21 can optionally include wherein the polymer is selected from the group comprising molecular imprinted polymers, peptides, nucleic acid aptamers, fluorine-containing polymers, antibodies, lectins.

In example 23 the subject matter of the Examples 18-22 can optionally include wherein the emitted optical energy has an evanescent field and the polymer is thinner than a thickness of the evanescent field.

In example 24 the subject matter of the Examples 18-23 can optionally include wherein the polymer terminates with a high-refractive-index polymer element, comprising an RI greater than 1.7, configured to enhance the change in RI when the polymer couples to the analyte.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A sensor comprising:
a substrate die;
a photonic ring resonator (RR) on the substrate die;
a polymer, on the RR, having an affinity to a chemical analyte;
a photonic waveguide on the substrate die and coupled to the RR;
a laser, on the substrate die and coupled to the waveguide, to emit optical energy that operates with the RR at a resonance wavelength; and
a photodetector, on the substrate die and coupled to the waveguide, to detect a change in refractive index (RI) of the RR that occurs in response to the polymer coupling to the analyte.

2. The sensor of claim 1, wherein the polymer has the affinity to the analyte when the polymer includes a member selected from the group comprising: a molecular imprint specific to the analyte, a physical printing specific to the analyte, and a photolithographed printing specific to the analyte.

3. The sensor of claim 2, wherein the analyte is selected from the group comprising liquid ketones, liquid alcohols, liquid aldehydes, volatile organic compounds (VOCs), metal ions, biomarkers, hormones, liquid esters, carboxylic acids, ethers, amines, halohydrocarbons (with F, Cl, Br, or I), proteins, and polypeptides.

4. The sensor of claim 1, wherein the polymer is reusable and does not degrade in response to coupling to the analyte.

5. The sensor of claim 1 including an array of RRs, on the substrate die, including the RR.

6. The sensor of claim 5, wherein each of the RRs includes an affinity specific to the analyte.

7. The sensor of claim 5, wherein an additional one of the RRs includes an affinity specific to an additional chemical analyte that is different from the analyte.

8. The sensor of claim 5 including an additional waveguide and a beam splitter coupled to the waveguide and the additional waveguide.

9. The sensor of claim 1, wherein the polymer couples to a surface of the RR so an analyte recognition motif of the polymer is less than 100 nm away from the surface.

10. The sensor of claim 1, wherein the emitted optical energy has an evanescent field and the polymer is thinner than a thickness of the evanescent field.

11. The sensor of claim 1, wherein the waveguide couples to the polymer via an oxide layer.

12. The sensor of claim 11, wherein the polymer couples to the oxide layer via a member selected from the group comprising amines, carboxyls, aldehydes, thiols, hydroxyls, and epoxies.

13. The sensor of claim 1, wherein the polymer terminates with a high-refractive-index polymer element, comprising an RI greater than 1.7, configured to enhance the change in RI in response to the polymer coupling to the analyte.

14. The sensor of claim 1, wherein the polymer includes a member selected from the group comprising peptides and aptamers.

15. The sensor of claim 1 including a control transducer on the substrate die that does not include a polymer with an affinity to the analyte.

16. The sensor of claim 1, wherein the polymer includes a molecularly imprinted polymer (MIP).

17. The sensor of claim 1 including a phase locked loop (PPL) on the substrate die and coupled to the laser; wherein the laser is tunable and the photodetector includes a photodiode.

18. A sensor comprising:
a substrate die;
a transducer on the substrate die;
a polymer, on the transducer, configured to include a programmed affinity to a chemical analyte;
a photonic waveguide on the substrate die and coupled to the transducer;
a laser, on the substrate die and coupled to the waveguide, to emit optical energy that operates with the transducer at a resonance wavelength; and
a photodetector, on the substrate die and coupled to the waveguide, to detect a change in refractive index (RI) of the transducer that occurs in response to the polymer coupling to the analyte.

19. The sensor of claim 18, wherein the polymer is reusable and does not degrade in response to coupling to the analyte when the polymer is programmed to include the affinity to the analyte.

20. The sensor of claim 18, wherein the transducer is selected from the group comprising a ring resonator (RR) and a surface plasmon resonator (SPR).

21. The sensor of claim 18 including an array of transducers.

22. The sensor of claim 18, wherein the polymer is selected from the group comprising molecular imprinted polymers, peptides, nucleic acid aptamers, fluorine-containing polymers, antibodies, lectins.

23. The sensor of claim 18, wherein the emitted optical energy has an evanescent field and the polymer is thinner than a thickness of the evanescent field.

24. The sensor of claim 18, wherein the polymer terminates with a high-refractive-index polymer element, comprising an RI greater than 1.7, configured to enhance the change in RI when the polymer couples to the analyte.
